(19) United States
(12) Patent Application Publication
(10) Pub. No.: US 2015/0019373 A1
(43) Pub. Date: Jan. 15, 2015

(54) PROVIDING A CONSUMER ADVOCATE RECOMMENDATION UTILIZING HISTORIC PURCHASING DATA

(71) Applicants: LEE A. CARBONELL, FLOWER MOUND, TX (US); TSZ S. CHENG, GRAND PRAIRIE, TX (US); JEFFREY L. EDGINGTON, KELLER, TX (US); PANDIAN MARIADOSS, ALLEN, TX (US)

(72) Inventors: LEE A. CARBONELL, FLOWER MOUND, TX (US); TSZ S. CHENG, GRAND PRAIRIE, TX (US); JEFFREY L. EDGINGTON, KELLER, TX (US); PANDIAN MARIADOSS, ALLEN, TX (US)

(73) Assignee: INTERNATIONAL BUSINESS MACHINES CORPORATION, ARMONK, NY (US)

(21) Appl. No.: 13/937,279

(22) Filed: Jul. 9, 2013

(51) Int. Cl. G06Q 30/06

(52) U.S. Cl. CPC G06Q 30/0631
USPC 705/26.7

(57) ABSTRACT

A good selected by a shopper within a commerce session can be identified. The commerce session can be associated with a provider. The provider can be associated with a product and/or a service. The commerce session can be associated with an e-commerce Web site and a physical retail site. Historic purchase data associated with the good can be determined. The historic purchase data can be associated with the shopper. A purchase pattern for the good can be established based on at least one of the historic purchase data and a personalization profile. The personalization profile can include a user preference and/or an event data associated with an event. The event can affect the future purchasing behavior of the shopper. A recommendation based on the purchase pattern can be provided. The recommendation can benefit the purchasing behavior of the shopper.

### BACKGROUND

The present invention relates to the field of commerce and, more particularly, to providing a consumer advocate recommendation utilizing historic purchasing data.

Traditionally, commerce tools have focused on providing support and enhancements to producers goods and/or services. For example, many tools exist for companies to cross-reference data and historic purchases to target advertisements at a consumer. These tools often provide the consumer with a copious amount of advertisements for goods and/or services. Consequently, consumers can be inundated with sales, deals, and purchasing opportunities which can be unfavorable. Unfavorable purchases can include, misleading deal pricing, surplus purchases, and impulse buys.

For example, a consumer can be unaware of existing goods which they already own and can purchase additional goods which create a large surplus which cannot be easily exhausted.

The following scenario that illustrates a common problem. Frequently, during shopping trips consumers discover an item which needs to be purchased. For example, when the consumer is at the grocery store, the consumer can decide to buy laundry detergent which is selling at a good price. When the consumer home the consumer discovers the already have two containers full of detergent. Some purchases can be cumbersome as consumers can easily forget to purchase common food items. For example, many shoppers can purchase bread every two weeks, but in the rush of everyday life the shopper can forget to buy bread when at the grocery store. Consequently, making additional trips to purchase items which have been forgotten consume additional resources (e.g., additional gasoline and wasted time). Yet another situation confronts consumers is perishable foods which when a large surplus occurs the food can quickly become unusable (e.g., vegetables can quickly rotten). As such, consumers need help in making purchasing decisions which exceed current consumer tool capabilities.

### BRIEF SUMMARY

One aspect of the present invention can include a system, an apparatus, a computer program product, and a method for providing a consumer advocate recommendation utilizing historic purchasing data. A good selected by a shopper within a commerce session can be identified. The commerce session can be associated with a provider. The provider can be associated with a product and/or a service. The commerce session can be associated with an e-commerce Web site and a physical retail site. Historic purchase data associated with the good can be determined. The historic purchase data can be associated with the shopper. A purchase pattern for the good can be established based on at least one of the historic purchase data and a personalization profile. The personalization profile can include a user preference and/or an event data associated with an event. The event can affect the future purchasing behavior of the shopper. A recommendation based on the purchase pattern can be provided. The recommendation can benefit the purchasing behavior of the shopper.

Another aspect of the present invention can include a method, an apparatus, a computer program product, and a system for providing a consumer advocate recommendation utilizing historic purchasing data. A recommendation engine can be able to provide a recommendation to a shopper during a commerce session. The recommendation can be a good or service recommendation. The recommendation can be generated utilizing a historic purchase data and/or a personalization profile. The personalization profile can include a user preference and/or an event data associated with an event. The event can affect the shopper's purchasing behavior. A data store can be configured to persist the historic purchase data, the recommendation, and/or the personalization profile.

### BRIEF DESCRIPTION OF THE SEVERAL VIEWS OF THE DRAWINGS

FIG. 1 is a schematic diagram illustrating a set of scenarios for providing a consumer advocate recommendation utilizing historic purchasing data in accordance with an embodiment of the inventive arrangements disclosed herein.

FIG. 2 is a schematic diagram illustrating a method for providing a consumer advocate recommendation utilizing historic purchasing data in accordance with an embodiment of the inventive arrangements disclosed herein.

FIG. 3 is a schematic diagram illustrating a system for providing a consumer advocate recommendation utilizing historic purchasing data in accordance with an embodiment of the inventive arrangements disclosed herein.

### DETAILED DESCRIPTION

The present disclosure is a solution for providing a consumer advocate recommendation utilizing historic purchasing data. In the solution, historic purchase data can be utilized to assist a consumer in performing purchases. The solution can be configured to allow a consumer to make intelligent purchases based on pricing data, item availability, and the like. For example, the disclosure can utilize inventory information of historic purchases to recommend a shopper to not purchase an item because the consumer already owns a suitable existing quantity. In one embodiment, the solution can permit the consumer to adapt to events which affect consumption. In the embodiment, the solution can recommend purchases to a consumer based on consumer-specific events, weather conditions (e.g., incoming storm), and the like. It should be appreciated that the solution can utilize pricing information, inventory data, and the like to create recommendations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

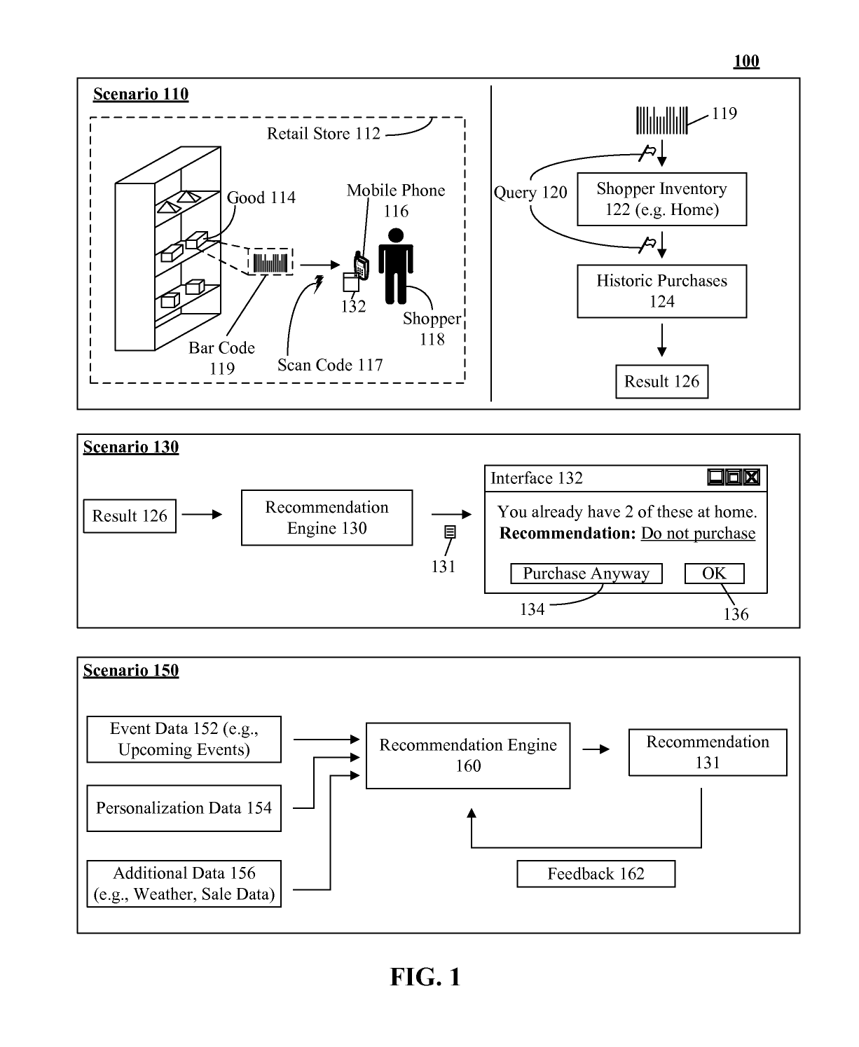

FIG. 1 is a schematic diagram illustrating a set of scenarios 110, 130, 150 for providing a consumer advocate recommendation utilizing historic purchasing data in accordance with an embodiment of the inventive arrangements disclosed herein. Scenarios 110, 130, 150 can be present in the context of method 200 and/or system 300. Scenarios 110, 130, 150 can occur in sequence and/or out of sequence. It should be appreciated that scenarios 110, 130, 150 are for exemplary purposes only and should not be construed to limit the invention in any regard. In scenario 110, a shopper 118 can inspect an item (e.g., good 144) within a retail store 112 during a commerce session (e.g., shopping trip). In scenario 130, a recommendation 131 can be generated from the results of a search of historic purchases for the item. In scenario 150, data 152, 154, 156 can be utilized to customize recommendation based on events affecting shopper 118 , shopper 118 preferences, and the like.

In scenario 110, the disclosure can assist a shopper 118 during a purchasing decision of an item (e.g., good 114). In the scenario 110, a shopper 118 within a retail store 112 can inspect a good 114 during a purchasing decision. For example, shopper 118 can pick a product off a shelf in a grocery store to examine the product. In one embodiment, good 114 can include a bar code 119 which can uniquely identify the good 114. In the embodiment, good 114 can include additional uniquely identifying information such as product name. Shopper 118 can utilize mobile phone 116 to perform scan code 117 action. Action 117 can read barcode 119 and process the barcode 119 information. For example, a barcode reader application (e.g., interface 132) executing within phone 116 can scan the barcode associated with the good 114. It should be appreciated that good 114 can be automatically identified utilizing one or more traditional and/or proprietary technologies. It should be appreciated that query 120 can be automatically triggered when a shopper 118 is proximate to a good 114. For example, when a shopper is close to a Radio Frequency Identification (RFID) tagged item, the phone 116 can automatically read the RFID tag and present an appropriate recommendation.

Scan code 117 can trigger query 120 to be performed on a shopper inventory 122 and/or a historic purchases 124. Query 120 can be utilized to determine if the good 114 has previously been purchased. In one instance, query 120 can be utilized to establish purchase date, purchase quantity, and the like. In the instance, query 120 can produce result 126. In one embodiment, result 126 can be presented within interface 132, permitting shopper 118 to view purchase history.

In scenario 130, a recommendation 131 can be generated to assist shopper 118 during a purchase decision. In the scenario, result 126 can be inputted into a recommendation engine 130 which can generate recommendation 131. Recommendation 131 can be presented within interface 132 executing within phone 116. For example, when a user scans a barcode of a canned good, a recommendation for purchasing or not purchasing the canned good can be presented in interface 132. In one embodiment recommendation 131 can present information about historic purchases and a recommended action. Recommended action can include a purchase action and/or a savings action. For example, the recommendation can indicate that the shopper 118 already owns two of the good 114 and should not purchase the good 114 again. That is, recommendation 131 can be a consumer advocate advice which can aid shopper 118.

In one embodiment, recommendation 131 can be interactive, allowing a shopper 118 to select one or more actions. In the embodiment, interaction with recommendation 131 can be utilized to determine shopper 118 response to recommendation 131 and/or associated action. For example, two actions can be presented permitting the shopper 118 to indicate compliance with recommendation 131 (e.g., ‘OK’) or rejection of recommendation 131 (e.g., ‘Purchase Anyway’). In one instance, the shopper 118 selection of actions 134, 136 can be utilized as feedback for subsequent recommendations 131. In the embodiment, shopper 118 can be prompted for a exemption when the recommendation is rejected. For example, when a shopper 118 rejects a recommendation, a comment form can be presented to indicate the reason for the rejection.

It should be appreciated that shopper 118 can purchase the item in a traditional and/or proprietary fashion. Purchasing can include usage of a self-checkout kiosk, point of sale kiosk, and the like.

In one instance, the disclosure can be utilized to advise purchases for exhaustible goods such as food, consumer-specific care items, consumer-specific electronics, books, music, art, and the like. In the instance, the disclosure can notify a shopper of a pending purchase based on historic usage of the good. For example, when a shopper purchases insecticides at the end of every month, the disclosure can alert the shopper to purchase insecticides appropriately.

In scenario 150, data 152, 154, 156 can be utilized by engine 160 to generate customized recommendation 131. Data 152, 154, 156 can be obtained from one or more source including, but not limited to, consumer-specific calendars, data feeds (e.g., Really Simple Syndication), preference settings, and the like. Data 152 can include, but is not limited to, date information, time information, event category information, attendee information, priority information, and the like. Data 154 can include, but is not limited to, usage behavior, behavior metrics, lifestyle settings, and the like. Additional data 156 can include, but is not limited to, weather data, commerce data (e.g., sales), social networking data, and the like. In one embodiment, engine 160 can utilize data 152-156 to generate recommendation 131. In the embodiment, engine 160 can employ traditional and/or proprietary technologies to generate recommendation. For example, engine can utilize weighting and fuzzy logic to determine a recommendation 131. Recommendation 131 can be associated with feedback 162 which can be manually and/or automatically collected. Feedback 162 from recommendation 131 can be conveyed to engine 160 which can utilize the feedback 162 to continuously improve recommendation 131.

Drawings presented herein are for illustrative purposes only and should not be construed to limit the invention in any regard. In the scenario 110, shopper inventory 122 and/or historic purchases 124 information can be obtained manually and/or automatically. In one embodiment, item tracking (e.g., 122, 124) can be performed through a discount card tracking (e.g., Rewards Card), product RFID tags, and the like. That is, the disclosure can leverage consumer-specific shopping analytics to assist the shopper 118. It should be appreciated that the disclosure can be embodied as a physical device (e.g., electronic keyfob), a wireless application (e.g., mobile application), and the like.

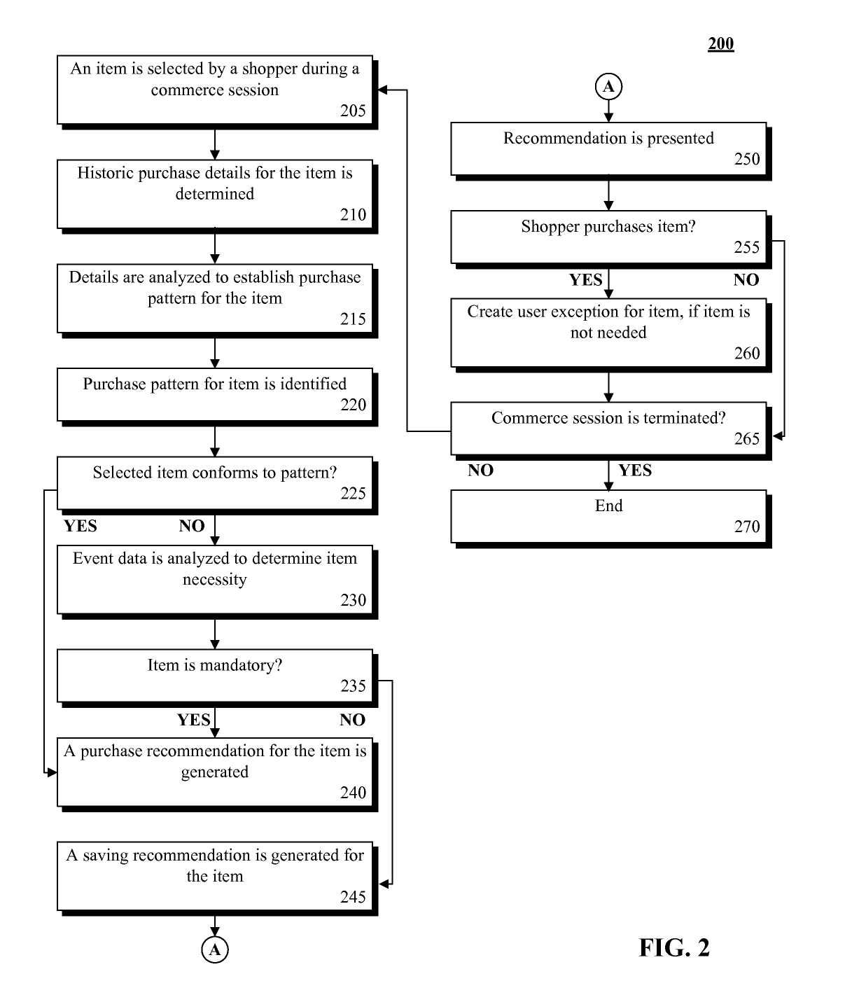

FIG. 2 is a schematic diagram illustrating a method 200 for providing a consumer advocate recommendation utilizing historic purchasing data in accordance with an embodiment of the inventive arrangements disclosed herein. Method 200 can be performed in the context of scenarios 110, 130,150 and/or system 300. Method 200 can be performed in real-time or near real-time. Method 200 can be performed in serial and/or in parallel.

In step 205, an item can be selected by a shopper during a commerce session. In step 210, historic purchase details for the item can be determined. In step 215, details can be analyzed to establish a purchase pattern for the item. In step 220, the purchase pattern can be identified. In step 225, if the selected item conforms to the purchase pattern, the method can continue to step 240, else proceed to step 230. In step 230, event data can be analyzed to determine item necessity. In step 235, if the item is mandatory, the method can continue to step 240, else proceed to step 245. In step 240, a purchase recommendation can be generated for the item. In step 245, a savings recommendation can be generated for the item. In step 250, the recommendation can be presented. In step 255, if the shopper purchases the item, the method can continue to step 260, else proceed to step 265. In step 260, a user exception can be created for the item. In step 265, if the commerce session is terminated the method can continue to step 270, else return to step 205. In step 270, the method can end.

Drawings presented herein are for illustrative purposes only and should not be construed to limit the invention in any regard. Steps 205-265 can be repeated throughout the commerce session.

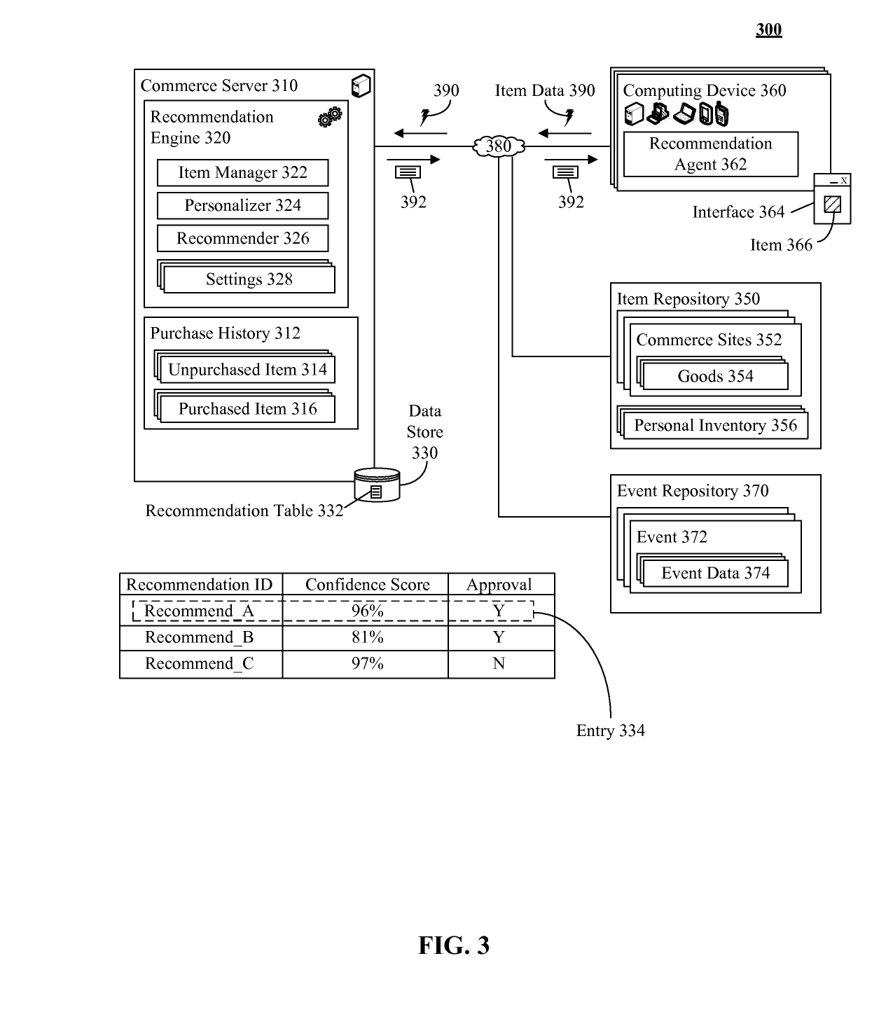

FIG. 3 is a schematic diagram illustrating a system 300 for providing a consumer advocate recommendation utilizing historic purchasing data in accordance with an embodiment of the inventive arrangements disclosed herein. System 300 can be present in the context of scenario 110, 130, 150, and/or method 200. System 300 components can be communicatively linked via one or more networks 380. System 300 can include, but is not limited to, a commerce server 310, a computing device 360, an item repository 350, an event repository 370, and the like.

Commerce server 310 can be a hardware/software entity for executing recommendation engine 320. Server 310 functionality can include, but is not limited to, file sharing, encryption, and the like. Server 310 can include, but is not limited to, recommendation engine 320, purchase history 312, data store 330, and the like. In one embodiment, server 310 can conform to a Service Oriented Architecture. In one instance, server 310 can be a functionality of an e-commerce server.

Recommendation engine 320 can be a hardware/software element for advising a consumer through one or more recommendations 392. Engine 320 functionality can include, but is not limited to, filtering, data aggregation, and the like. Engine 320 can include, but is not limited to, item manager 322, personalizer 325, recommender 326, settings 328, and the like. In one instance, engine 320 can include a client-server component architecture. In the instance, engine 320 functionality can be presented within a recommendation agent 362 executing on device 360.

Item manager 322 can be a hardware/software entity for handling items such as goods and/or services. Item manager 322 functionality can include, but is not limited to, item tracking, item identification, item pricing (e.g., sale pricing, coupons, etc), and the like. In one instance, item manager 322 can receive item data 390 (e.g., item 366) from device 360 which can be utilized to identify a good and/or service selected by a shopper. In the instance, item data 390 can include, but is not limited to text identifiers (e.g., name of the item), image data (e.g., picture of the item), barcode data, and the like. In one embodiment, manager 322 can be utilized to track one or more consumer-specific inventories 356 associated with a shopper. In the embodiment, tracking can include, but is not limited to, location information, quantity information, pricing information, and the like. For example, manager 322 can permit a shopper to track an inventory of purchased goods at two different houses owned by the shopper.

Personalizer 324 can be a hardware/software element for customizing recommendations 392. Personalizer 324 functionality can include, but is not limited to, personal data aggregation, behavior metric collection, and the like. For example, personalizer 324 can be utilized to determine how quickly a shopper exhausts an item. Personalizer 324 can be employed to collect item purchase information from real world purchases, e-commerce purchases, and the like. In one instance, personalizer 324 can be a Web browser plug-in which can track purchases within an e-commerce session. In one embodiment, personalizer 324 can be employed to analyze feedback from a recommendation 392 to improve subsequent recommendations. In one instance, personalizer 324 can support multiple shopper preferences, multiple locations (e.g., location specific behavior), and the like.

Recommender 326 can be a hardware/software entity for generating recommendation 392 for an identified item 366. Recommender 326 functionality can include, but is not limited to, behavior analysis, recommendation ranking, feedback collection, and the like. In one instance, recommender 326 can leverage a purchase history 312 to determine historic decisions. In the instance, recommender 326 can utilize pricing data, user comments (e.g., reason an item was/wasn't purchased), date information, and the like to generate an appropriate recommendation 392. In one instance, recommender 326 can accommodate for events 372, time horizons which require item purchases, and the like. In the instance, event data 372 can be analyzed to determine relevant purchases which can be recommended to a shopper.

Settings 328 can be one or more rules for configuring the behavior of system 300, server 310, and/or engine 320. Settings 328 can include, but is not limited to, manager 322 settings, personalizer 324 options, recommender 326 settings, and the like. In one instance, settings 328 can be persisted within data store 330, engine 320, device 360 (e.g., agent 362), and the like. In one embodiment, settings 328 can be manually and/or automatically established. In the embodiment, settings 328 can be heuristically determined from historic settings.

Purchase history 312 can be one or more data sets which can be manually and/or automatically established based on shopper behavior. Purchase history 312 can be obtained from one or more sources including, but not limited to, computing devices, kiosks (e.g., checkout kiosks), e-commerce sites, receipts (e.g., OCRed), and the like. History 312 can include, but is not limited to, unpurchased item 314, purchased item 316, and the like. In one instance, history 312 can include item description information, item pricing, item availability, item retailer, and the like. That is, history 312 can be a comprehensive catalog of items considered by a shopper during one or more shopping trips (e.g., commerce sessions).

Data store 330 can be a hardware/software component able to persist recommendation table 332, purchase history 312, event 374 data, and the like. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to server 310 in one or more traditional and/or proprietary mechanisms. In one instance, data store 330 can be a component of Structured Query Language (SQL) complaint database.

Recommendation table 332 can be one or more data sets for tracking recommendations. Recommendation table 332 can include, but is not limited to, a recommendation identifier, a confidence score, an approval value, and the like. For example, table 332 can include an entry 334 which can track the historic acceptance (e.g., ‘Y’) of a strong (e.g., 96%) recommendation (e.g., Recommend_A). In one instance, recommendation table 332 can be automatically generated and/or maintained by recommender engine 320. It should be appreciated that table 332 can encompass any data structure and is not limited to the structure described herein.

Computing device 360 can be a software/hardware element for executing agent 362, interface 364, and the like. Device 360 can include, but is not limited to, input components (e.g., keyboard), interface 364, an application (e.g., recommendation agent 362), output components (e.g., display), and the like. Device 360 hardware can include, but is not limited to, a processor, a non-volatile memory, a volatile memory, a bus, and the like. Computing device 360 can include, but is not limited to, a desktop computer, a laptop computer, a mobile phone, a mobile computing device, a portable media player, a PDA, and the like. For example, device 360 can be a mobile phone executing a shopping list program which can include the functionality described herein.

Interface 364 can be a user interactive component permitting interaction and/or presentation of item 366, item data 392, recommendation 392, and the like. Interface 364 can be present within the context of a Web browser application, a consumer-specific information manager, a commerce application, and the like. In one embodiment, interface 364 can be a screen of a recommendation agent 362. Interface 364 capabilities can include a graphical user interface (GUI), voice user interface (VUI), mixed-mode interface, and the like. In one instance, interface 364 can be communicatively linked to computing device 360.

Item repository 350 can be a hardware/software entity able to persist items information such as goods 354 and/or services. Repository 350 can include one or more commerce sites 352. Commerce sites 352 can include physical establishments (e.g., retail outlets) and electronic commerce entities (e.g., e-commerce Web sites). Goods 354 can include site 352 specific goods, special availability goods, and the like. In one instance, repository 350 can be dynamically updated utilizing one or more data sources permitting recommendations 392 to be current.

Event repository 370 can be a hardware/software element configured to persist event 372. Repository 370 can include, but is not limited to, a calendaring server, a calendar file, and the like. Event 372 can include event data 374 which can be utilized to determine event type, event priority, item requirements, and the like. For example, event data 374 can be analyzed to determine an upcoming birthday which can be associated with birthday item purchases such as balloons, cake, and/or party supplies.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), Virtual Private Network (VPN) and the like.

In one embodiment, the disclosure can be utilized to create a dynamic shopping list which can be generated from historic purchase activities and/or user preferences. In one instance, the disclosure can be utilized to automatically add items to a grocery list a shopper has forgotten. In one embodiment, the disclosure can be employed to present price comparisons of historic item prices and current item prices. In one instance, the disclosure can assist the shopper in avoiding potential excessive purchases, potential excessive purchases at a discounted price, and the like. In another instance, the disclosure can aid the shopper in purchasing seasonal items which at the best commerce site (e.g., based on price, location, etc).

Drawings presented herein are for illustrative purposes only and should not be construed to limit the invention in any regard. It should be appreciated that one or more components within system 300 can be optional components permitting that the disclosure functionality be retained. It should be understood that engine 320 components can be optional components providing that engine 320 functionality is maintained. It should be appreciated that one or more components of engine 320 can be combined and/or separated based on functionality, usage, and the like. It should be understood that the disclosure can utilize local storage and/or remote storage solutions. In one instance, the system 300 can utilize cloud computing storage to enable ubiquitous usage. For example, the disclosure can leverage cloud based point of sale systems. In one embodiment, the system 300 can utilize existing point of sale functionality such as inventory management, analytics, bookkeeping, inventory tagging abilities, and the like.

In one embodiment, the disclosure can support good sales (e.g., special pricing), good returns, good exchanges, layaways, gift cards, gift registries, customer loyalty programs, buy one get one free (BOGO) deals, quantity discounts, and the like. Further, the disclosure can track promotional sales, coupon redemption, foreign currencies, payment types, and the like.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for recommending consumer purchases comprising:
identifying a good selected by a shopper within a commerce session, wherein the commerce session is associated with a provider, wherein the provider is associated with at least one of a good and a service, wherein the commerce session is associated with an e-commerce Web site and a physical retail site;
determining historic purchase data associated with the good, wherein the historic purchase data is associated with the shopper;
establishing a purchase pattern for the good based on at least one of the historic purchase data and a personalization profile, wherein the purchase pattern is a historic purchasing behavior associated with the good, wherein the personalization profile comprises of at least one of a user preference and an event data associated with an event, wherein the event affect the subsequent purchasing behavior of the shopper ;
providing a recommendation based on the purchase pattern, wherein the recommendation benefit the purchasing behavior of the shopper.

2. The method of claim 1, wherein the recommendation is not to purchase the good.

3. The method of claim 1, wherein the identifying is performed automatically responsive to receiving a good identifier.

4. The method of claim 1, further comprising:
indicating a quantity of items previously purchased by the shopper, wherein the items is identical to the good.

5. The method of claim 1, further comprising:
analyzing the event data, wherein the event data is at least one of a weather condition, a planned event, an unplanned event, and an event associated with a different shopper.

6. The method of claim 5, further comprising:
generating a shopping list for the shopper based on the analyzing.

7. The method of claim 1, further comprising:
detecting the purchase of the good by the shopper; and
storing information associated with the purchase within the historic purchase data, wherein the information comprises of at least one of a price, a date, a time, a site identifier, and a comment.

8. The method of claim 1, further comprising:
detecting the purchase of the good at a point of sale kiosk within a physical retail site; and
storing information associated with the purchase within the historic purchase data, wherein the information comprises of at least one of a price, a date, a time, a site identifier, and a comment.

9. The method of claim 1, further comprising:
responsive to the identifying, comparing the price of the good at a first commerce site with the price of the good at a second commerce site;
presenting a notification indicating at least one of the price difference and a commerce site identifier.

10. A system for recommending consumer purchases comprising:
a recommendation engine able to provide a recommendation to a shopper during a commerce session, wherein the recommendation is a good or service recommendation, wherein the recommendation is generated utilizing at least one of a historic purchase data and a personalization profile, wherein the personalization profile comprises of at least one of a user preference and an event data associated with an event, wherein the event affects the shopper; and
a data store configured to persist at least one of the historic purchase data, the recommendation, and the personalization profile.

11. The system of claim 10, further comprising:
an item manager configured to determine a good detail of the good, wherein the good detail is at least one of a price, a commerce site, and a comment;
a personalizer able to analyze the event data and discover at least one purchasing pattern associated with the good; and
a recommender configured to determine at least one recommendation associated with the good.

12. The system of claim 12, wherein the engine is a functionality of a mobile software application executing within a computing device, wherein the application is configured to present an evaluation of a pricing of a good within a commerce site proximate to the computing device, wherein the evaluation is determined utilizing at least one of the historic purchase data, sale pricing data, and a social networking data.

13. The system of claim 11, wherein the item manager is configured to determine a quantity of items similar to the good owned by the shopper.

14. The system of claim 11, wherein the personalizer is able to establish at least one event occurring within a previously established time horizon, wherein the event requires the purchase of a good.

15. The system of claim 11, wherein the recommender is configured to present a plurality of recommendations associated with the good.

16. The system of claim 11, wherein the recommender is able to determine the at least one recommendation based on feedback from a historic recommendation.

17. The system of claim 10, wherein the recommendation engine is configured to generate a shopping list for the shopper based on analyzing the event data, wherein the event data is at least one of a weather condition, a planned event, an unplanned event, and an event associated with a different shopper.

18. The method of claim 10, wherein the recommendation is at least one of an excessive purchase notification and an overdue purchase notification.

19. A computer program product comprising a computer readable storage medium having computer usable program code embodied therewith, the computer usable program code comprising:
computer usable program code stored in a storage medium, if said computer usable program code is executed by a processor it is operable to identify a good selected by a shopper within a commerce session, wherein the commerce session is associated with a provider, wherein the provider is associated with at least one of a good and a service, wherein the commerce session is associated with an e-commerce Web site and a physical retail site;
computer usable program code stored in a storage medium, if said computer usable program code is executed by a processor it is operable to determine a historic purchase data associated with the good, wherein the historic purchase data is associated with the shopper;
computer usable program code stored in a storage medium, if said computer usable program code is executed by a processor it is operable to establish a purchase pattern for the good based on at least one of the historic purchase data and a personalization profile, wherein the personalization profile comprises of at least one of a user preference and an event data associated with an event, wherein the event affects the shopper;
computer usable program code stored in a storage medium, if said computer usable program code is executed by a processor it is operable to provide a recommendation based on the purchase pattern, wherein the recommendation benefits the shopper.

20. The computer program product of claim 19, wherein the product automatically manages an inventory of goods purchased by the consumer.
